(19) United States
(12) Patent Application Publication
(10) Pub. No.: US 2012/0019449 A1
(43) Pub. Date: Jan. 26, 2012

(54) TOUCH SENSING ON THREE DIMENSIONAL OBJECTS

(75) Inventors: Esat Yilmaz, Eastleigh (GB); Christopher Ard, Eastleigh (GB)

(73) Assignees: ATMEL CORPORATION; QRG LIMITED

(21) Appl. No.: 12/843,427

(22) Filed: Jul. 26, 2010

(51) Int. Cl. G06F 3/041

(52) U.S. Cl. 345/173

(57) ABSTRACT

Examples of touch sensors are capable of determining the position of one or more touches and/or gestures on a three dimensional object.

### BACKGROUND

A position sensor is a device that can detect the presence and location of a touch by a user's finger or by an object, such as a stylus, for example, within a display area of the position sensor overlaid on a display screen. In a touch sensitive display application, the position sensor enables a user to interact directly with what is displayed on the screen, rather than indirectly with a mouse or touchpad. Position sensors can be attached to or provided as part of computers, personal digital assistants (PDA), satellite navigation devices, mobile telephones, portable media players, portable game consoles, public information kiosks, and point of sale systems etc. Position sensors have also been used as control panels on various appliances.

There are a number of different types of position sensors/touch screens, such as resistive touch screens, surface acoustic wave touch screens, capacitive touch screens etc. A capacitive touch screen, for example, may include an insulator, coated with a transparent conductor in a particular pattern. When an object, such as a user's finger or a stylus, touches or is provided in close proximity to the surface of the screen there is a change in capacitance. This change in capacitance is sent to a controller for processing to determine the position of the touch on the screen.

In recent years, touch screens have typically been used to sense the position of a touch in two dimensions.

### SUMMARY

The following disclosure describes applications relating to providing touch sensors which are capable of determining the positions and/or gestures of one or more touches on a three dimensional object.

### BRIEF DESCRIPTION OF THE DRAWINGS

The drawing figures depict one or more implementations in accordance with the present teachings, by way of example only, not by way of limitation. In the figures, like reference numerals refer to the same or similar elements.

FIG. 1 illustrates schematically a two dimensional sensing grid for a touch sensor;

FIG. 2 illustrates a perspective view of a two dimensional sensing grid applied to a three dimensional object;

FIG. 2A illustrates schematically a push/pull gesture mapped onto the two dimensional sensing grid of FIG. 2;

FIG. 2B illustrates schematically a rotate gesture mapped onto a two dimensional sensing grid of FIG. 2;

FIG. 2C illustrates schematically a screw gesture mapped onto a two dimensional sensing grid of FIG. 2;

FIG. 3 illustrates a two dimensional sensing grid deformed to create a three dimensional object;

FIG. 4 illustrates a top view of a sensing grid applied to a steering wheel;

FIG. 5 illustrates a perspective view of a sensing grid applied to a three dimensional steering wheel;

FIG. 6 illustrates a sensing grid applied to a cone shaped object;

FIG. 7 illustrates a sensing grid applied to a pyramidal shaped object;

FIG. 8 illustrates a sensing grid applied to a cube shaped object;

FIG. 9 illustrates schematically a side view of a touch sensitive screen; and

FIG. 10 illustrates schematically apparatus for detecting and processing a touch at a touch sensitive screen.

### DETAILED DESCRIPTION

In the following detailed description, numerous specific details are set forth by way of examples in order to illustrate the relevant teachings. In order to avoid unnecessarily obscuring aspects of the present teachings, those methods, procedures, components, and/or circuitry that are well-known to one of ordinary skill in the art have been described at a relatively high-level.

In the examples, touch sensors which are capable of determining the position of a touch on a three dimensional object are described. The examples shown and described implement a capacitive form of touch sensing. In one exemplary configuration sometimes referred to as a mutual capacitance configuration, an array of conductive drive electrodes or lines and conductive sense electrodes or lines can be used to form a touch screen having a plurality of capacitive nodes. A node is formed at each intersection of drive and sense electrodes. Although referred to as an intersection, the electrodes cross but do not make electrical contact. Instead, the sense electrodes are capacitively coupled with the drive electrodes at the intersection nodes.

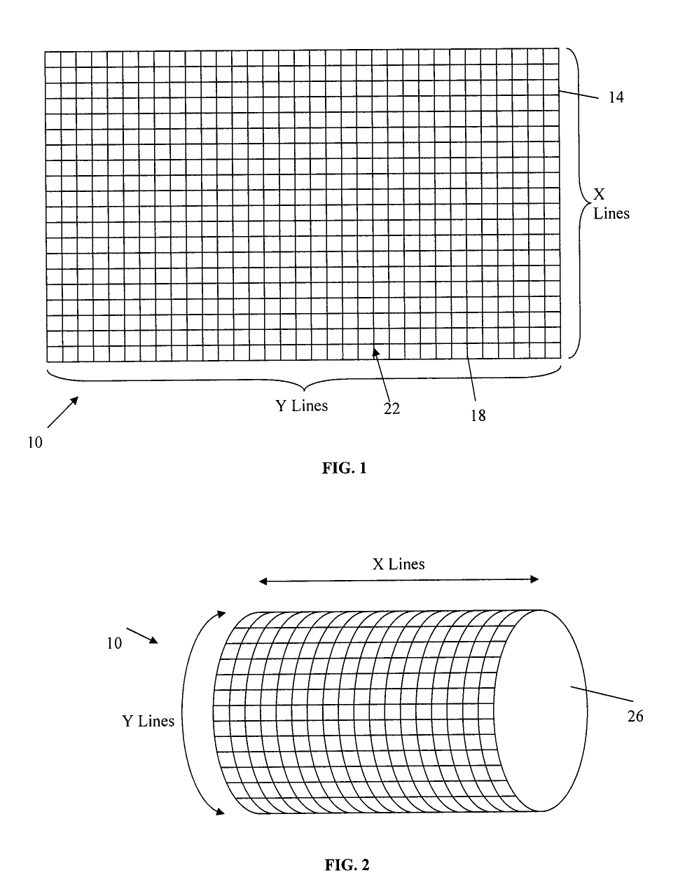

FIG. 1 illustrates schematically a two dimensional sensing grid 10 that can be used in a touch sensor. A sensing grid 10 includes a plurality of drive electrodes 14 (the X lines in FIG. 1) and a plurality of sense electrodes 18 (the Y lines in FIG. 1). Nodes 22 are formed at the intersections of the drive and sense electrodes. In one example, a change of capacitance detected at a node 22 indicates a touch at the position of the node. Any touch detected at the touch sensor has a position defined in two dimensions, in one example as x and y coordinates, by the position on the sensing grid 10.

The drive and sense electrodes can be configured to form any particular pattern as desired and are not limited to the arrangement illustrated in FIG. 1. In other configurations, the sense electrodes 18 may extend in the x direction and the drive electrodes 10 may extend in the y direction.

Although logically the grid 10 is two dimensional, the sensing grid 10 may be applied to a three dimensional object. The grid is applied to any desired surface of the three dimensional object. The surface of the object has a three-dimensional contour. Thus, in addition to or instead of being able to detect touch and movement in a two dimensional plane, other gestures or motions such as rotation can be detected in three dimensions. By applying the two dimensional grid to the three-dimensional object, the input information is used to determine, and in some cases track, touch position using two dimensional sensing techniques.

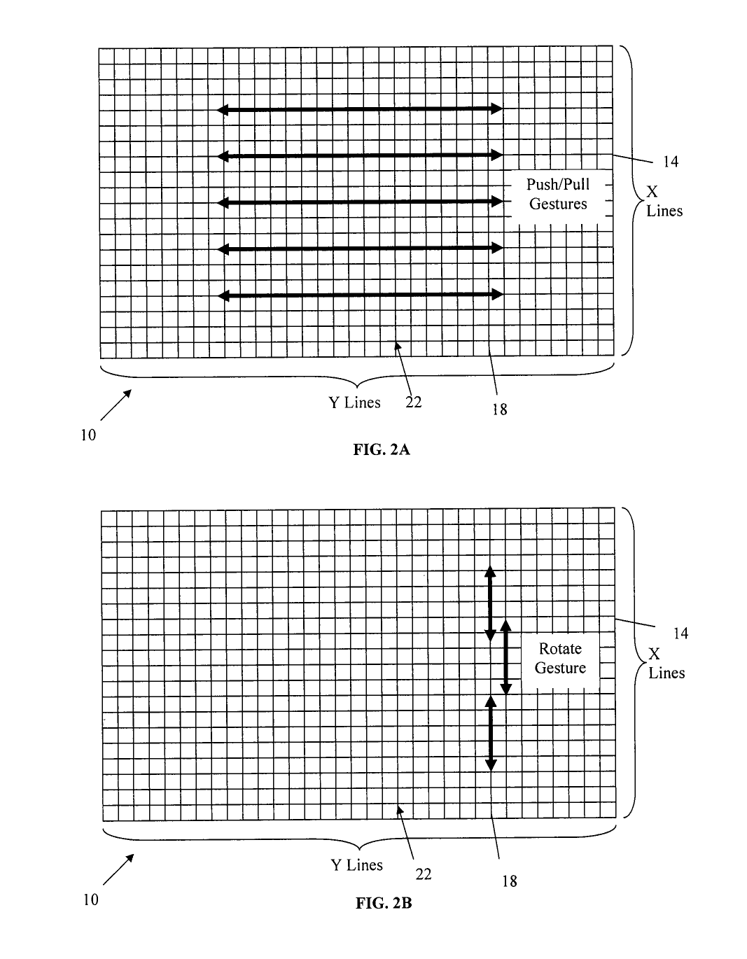

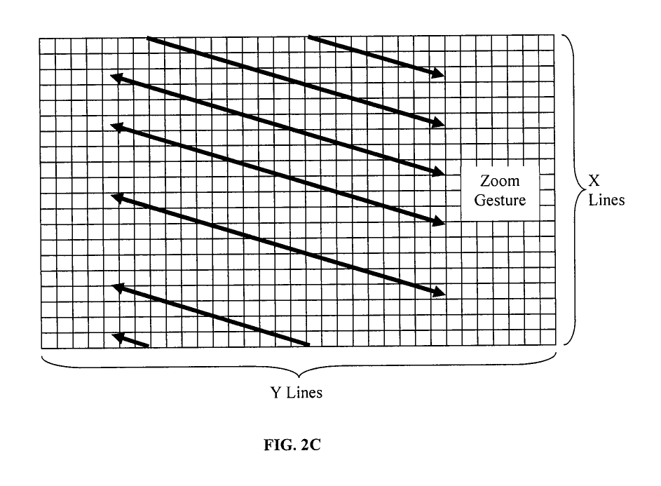

FIG. 2 illustrates schematically a three dimensional object, such as a control knob 26 having the two dimensional sensing grid 10 applied thereto. The control knob 26 may be a finger tip control knob that is used to control volume on a music system. The control knob 26 can be used to control functions on other electronic devices or appliances as well, for example, the temperature setting on an oven via a similar control knob. The control knob 26 may also be a hand grip, such as an accelerator of a motorcycle or other mode of transportation.

Specifically, in the case of capacitance based sensing when an object, such as a user's finger or a stylus, touches or is provided in close proximity to the node there is a change in capacitance. This change in capacitance is sent to a controller for processing to determine the position where the change in capacitance occurred. Over time, as capacitance changes are detected at different nodes, movement of the touching object can be determined. The user's finger(s)/hands do not need to be in contact with the three dimensional object. For example, the provision of the user's finger(s) proximity to the object can be interpreted as a touch depending on the sensitivity of the touch sensitive object.

On an object surface having a three dimensional contour, the electrodes no longer follow strictly straight lines but are curved, bent at angles, etc., to follow the surface contour. In the example of FIG. 2, a sensing grid 10 like that of FIG. 1 is applied to the cylindrical surface of the knob 26. As such, electrodes follow the contour of the cylindrical surface of the knob 26. In the example, the Y lines are shown as circular around the lateral extent of the cylindrical surface, while the X are still straight and extend in the longitudinal direction along the cylindrical surface, although the X and Y lines could be more angled and to have other shapes along the surface. Sliding touches at the cylindrical surface of the knob 26 can be detected and used to indicate movement in a specified direction (e.g., along the X lines 14). In this example, a detected touch movement in the x direction can be thought of as a pull or push event. One or more functions can be assigned to a pull or push event. For example, a radio can be turned on or off depending on the determined direction of movement.

If touches are detected and indicate movement around the knob 26 (e.g., along the Y lines 18), any of these changes in touch positions can be thought of as a rotational event. Various functions can be associated with the rotational event. An example can be to increase or decrease the volume of a radio or other audio or video system. The control function is based on the determined direction of touch rotation.

In a more detailed example, a pull gesture is determined if n (where n equals any number from 1 to 5) substantially parallel objects (e.g. fingers) are sensed touching and moving in the positive x direction (from left to right) as illustrated in FIG. 2A. A push gesture at the knob is determined if n substantially parallel objects (fingers) are sensed touching and moving in the negative x direction as illustrated in FIG. 2A.

Also, a rotational gesture is determined at the knob if n fingers are sensed moving in the Y direction as illustrated in FIG. 2B. In the example of a volume control knob, if n fingers are sensed moving in the positive y direction, then an increase in volume is determined. If n fingers are sensed moving in the negative y direction, then a decrease in volume is determined. Various methods of determining the direction an item (e.g., a finger) touching the grid is moving can be used, such as techniques used and associated with tracking the movement of one or more object touches across a two dimensional sensing grid 10, and are not described in detail herein in the interest of brevity.

For other applications, a combination of two of gestures may be detected, might be interpreted as another type of touch gesture. For example, a screw gesture, corresponding to a three dimensional screwing movement, combines touch movement in both the x direction and the y direction. Such gestures might be detected and interpreted as zoom-in and zoom out command inputs, and the in/out aspects of the input gestures might be distinguished based on positive/negative direction determinations. Although the user touches the object and moves the fingers in a compound gesture over the object in three dimensions, the X-Y touch grid provides touch coordinates analogous to coordinates of a two-dimensional flat grid. The three-dimensional screw gesture, with a number of fingers touching the object during the gesture, would be detected as a plurality of linear touch movements, such as those shown by way of example in FIG. 2C. The controller would determine that the user had performed the screw gesture if n (where n equals any number from 1 to 5) substantially parallel objects (e.g. fingers) are sensed touching and moving in a diagonal direction combining both x direction movement and y direction movement, perhaps where magnitude of movement in both directions exceeds a threshold to avoid a false classification of the gesture, when the gesture was predominantly push-pull or rotational. The controller may determine positive and negative directions of the gesture in one or both of x and y, for the screwing movements, much like for the positive and negative directions in x and y in the examples of FIGS. 2A and 2B. Zoom-in and zoom out commands are mentioned here as examples of inputs that might utilize the screw gesture detection. However, screw gestures may be used for inputs of other commands; and if the direction is detected in both x and y, the variability of the commands may be somewhat greater than the in/out input in the zoom control example.

In another example, the two dimensional sensing grid 10 is applied to a joystick. A joystick can be treated as an elongated form of the knob illustrated in FIG. 2.

In examples where the three dimensional object is likely to be gripped by a user's hand(s) as opposed to touched with a user's fingers, such as a steering wheel and joy stick examples, gestures at the object can be determined by monitoring movements at the touch sensing grid caused by gaps between the user's hand and the grid. For example, if a user grips a steering wheel by the hand, most of the hand is in contact with the surface of the steering wheel, so axial rotation events may not be easily detected. In this example, in most instances there will be gaps formed between contact points of the user's hand and the steering wheel, which can be detected and tracked. The position changes (e.g., movements) of these gaps are sensed in order to determine an axial rotation event.

In the steering wheel and joystick examples, instead of or in addition to tracking changes in capacitance for a transition from no touch detection to touch detection, a system using the three dimensional touch detection can also detect and track changes in capacitance for a transition from touch detection to no touch detection.

Using the above-described techniques, the movement of one or more touches on the grid is measured instead of the actual movement of the three dimensional object. The three dimensional object itself can remain stationary. In the knob example of FIG. 2, the knob does not need to rotate in the x direction, instead movement of the user's fingers across the surface of the knob is interpreted as turning the knob and consequently, indicating a user desired increase/decrease in the volume etc. Similarly, the knob does not need to move in or out in the y direction, instead movement of the user's fingers longitudinally along the cylindrical surface of knob is interpreted as pushing in or pulling out of the knob and consequently, for example, indicating a user's desire to turn on or off the controlled device.

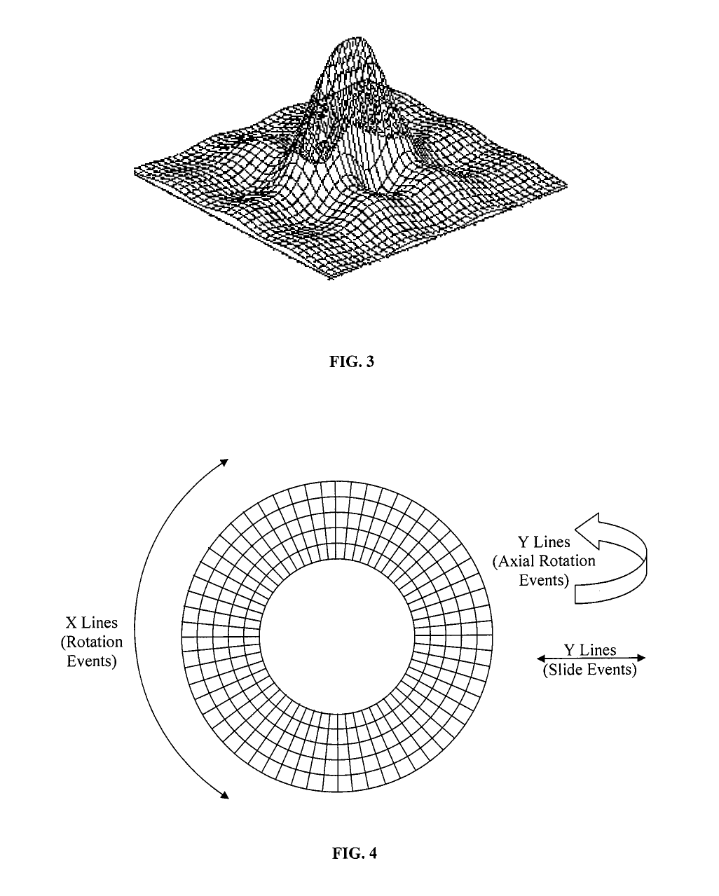

FIG. 3 illustrates another example of a control knob. In the example of FIG. 3, the knob has been created by forming a protrusion in the two dimensional grid of FIG. 1. In this example, the protrusion which forms the knob has a surface having a more complex three dimensional contour, however, any touches detected at the knob of FIG. 3 are detected as touches at a grid of X and Y electrodes. In this way, the three dimensional position and/or movement of touch at the object surface is translated by the sensing at nodes on the three dimension object into the equivalent of the sensing on a flat two dimensional grid. The logic for the control functions, such as volume control and ON/OFF control in our earlier example, may be based on knowledge of the complex three dimensional contour and thus the position(s) of touches in three dimensions.

FIG. 4 illustrates another example of applying a sensing grid to a three dimensional object. As shown, FIG. 4 represents a top view of a three dimensional object such as a steering wheel. The two dimensional touch sensing grid may take a circular shape. Functions can be assigned to slide events/gestures (along the Y lines) and to rotation events/gestures (along the X lines). These functions are defined prior to use. Again the gestures can be assigned to cause certain functions to occur, when respective gestures are detected.

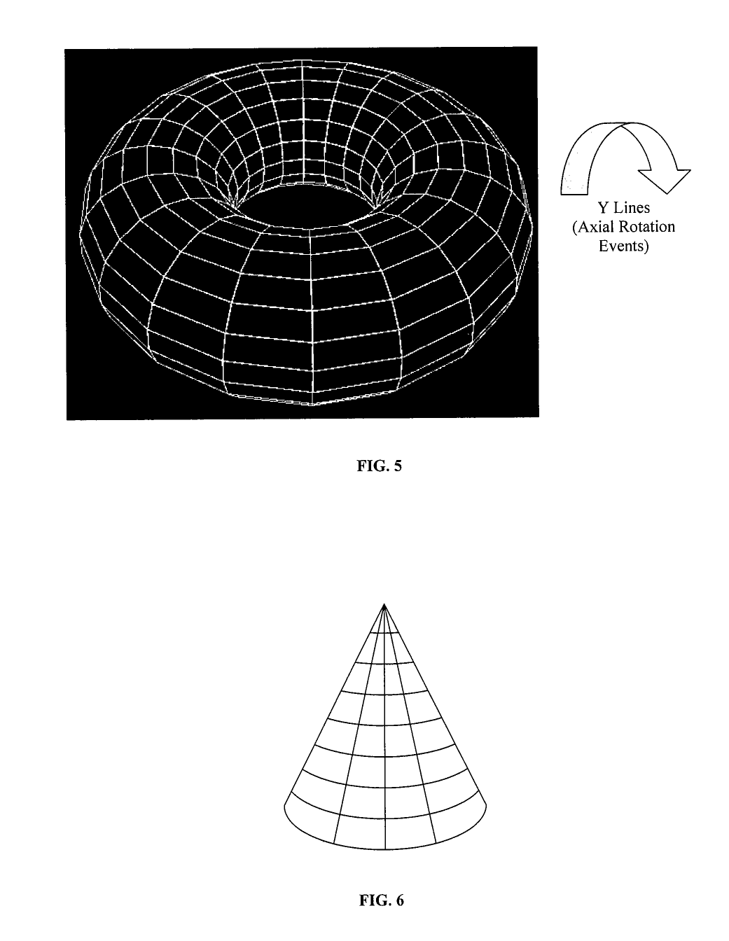

In the example of FIG. 5, the touch sensor is applied to the entire surface of the steering wheel. Therefore, it is possible to detect axial rotation events about a tangential axis at a location where a user may grip the wheel as touch movements in the Y direction of FIGS. 4 and 5. These axial rotation events in one example indicate desired acceleration/deceleration. If the wheel is stationary, it may also be possible to detect axial rotation events about the central axis of the entire wheel as movements in the X direction of FIGS. 4 and 5, for example, analogous to the user turning a mechanical steering wheel to indicate desired direction of vehicle movement. In one example, the steering wheel of FIG. 5 is created by bending the ends of the tube of FIG. 2 such that the ends meet and form a donut shape. As discussed above, a two dimensional touch sensing grid is applied to the three dimensional object and the detected touches on the three dimensional object are detected on the equivalent of a two dimensional grid. If laid flat, there would be no Z direction on the sensing grid, but on the object surface, the nodes of the grid are distributed in three dimensions and detect touches and gestures at various locations in three dimensions about the three dimensional object.

The steering wheel may be a steering wheel for a vehicle, or may be a computer game steering wheel etc.

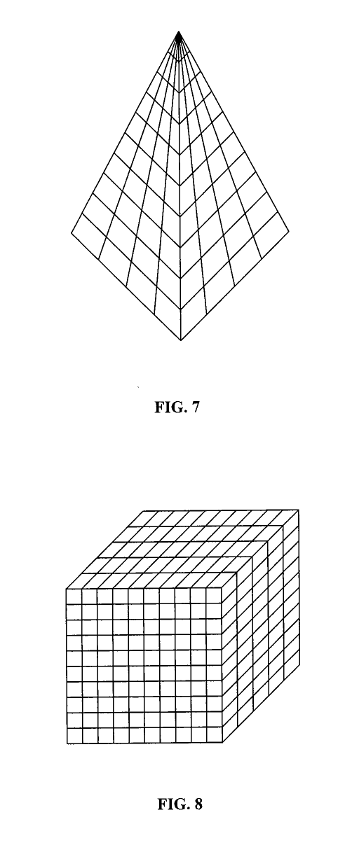

In other examples, touch sensing grids are applied to one or more surfaces of other three dimensional objects, such as cones (illustrated in FIG. 6), pyramids (illustrated in FIG. 7), and cubes (illustrated in FIG. 8), to make objects of such shapes touch sensitive.

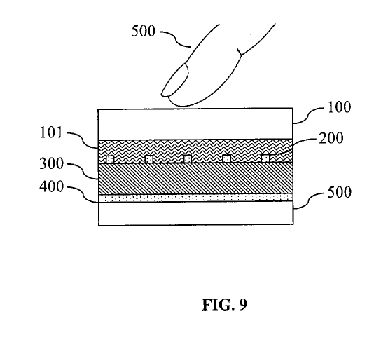

FIG. 9 illustrates a side view of an exemplary position sensor. The position sensor of FIG. 9 is made up of a cover panel 100, an adhesive layer 101, a first conductive electrode layer 200, a substrate 300, a second conductive electrode layer 400, and a protective layer 500.

The first conductive electrode layer 200 includes a plurality of sense electrodes and the second conductive electrode layer 400 includes a plurality of drive electrodes described above with reference to FIGS. 1 and 2. The drive and sense electrodes can be configured to form any particular pattern as desired. In FIG. 9, the drive electrodes are arranged perpendicular to the sense electrodes such that only the side of one of the drive electrodes is visible in the side view.

In examples that include the panel, the panel 100 is made of a resilient material suitable for repeated touching. Examples of the panel material include glass, Polycarbonate or PMMA (poly(methyl methacrylate)). In other examples, however, the panel 100 is not required. The substrate 300 and the protective layer 500 may be dielectric materials. The first and second conductive electrode layers 200, 400, may be made of PEDOT (Poly(3,4-ethylenedioxythiophene)) or ITO (indium tin oxide).

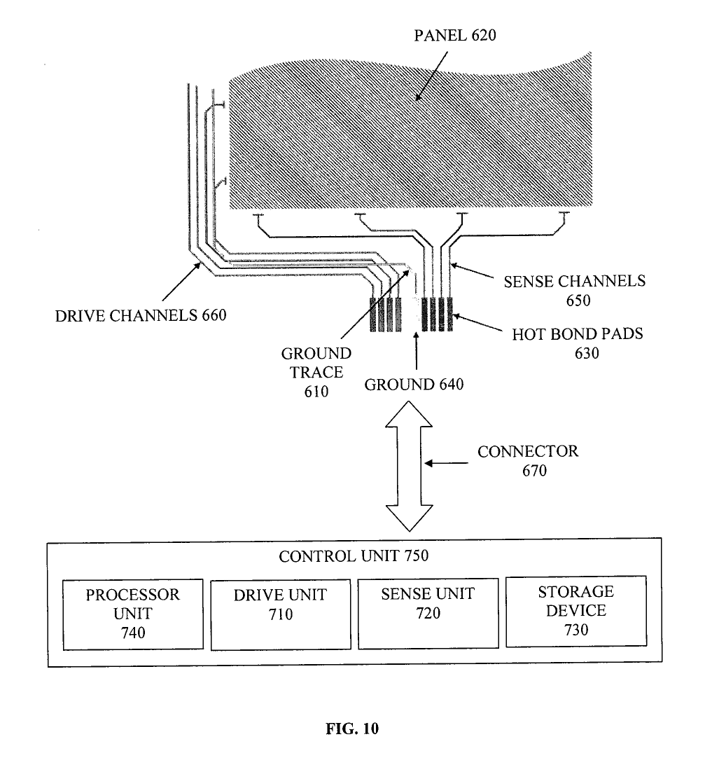

A panel of drive and sense electrodes, as illustrated in FIGS. 1 to 8, are supported by associated electronics that determine the location of the various touches and detect movement of items (e.g., fingers) in various directions. FIG. 10 illustrates schematically apparatus for detecting and processing a touch at a position sensor 620. In this example the position sensor 620 comprises the plurality of drive electrodes connected to drive channels 660 and the plurality of sense electrodes connected to sense channels 650. The drive and sense channels 650, 660 are connected to a control unit 750 via a connector 670. The control unit 750 may be provided as a single integrated circuit chip such as a general purpose microprocessor, a microcontroller, a programmable logic device/array, an application-specific integrated circuit (ASIC), or a combination thereof. In one example the control unit 750 includes a drive unit 710, a sense unit 720, a storage device 730 and a processor unit 740. The processor unit 740 is capable of processing data from the sense unit 720 and determining a position of a touch. The processor unit 740 can also track the changes in the position of touches to determine motion as described above. In an implementation where the processor unit 740 is a programmable device, the programming of the sense electrodes may reside in the storage device 730. In one example, the drive unit 710, sense unit 720 and processor unit 740 are all provided in separate control units.

In some examples, the processor unit 740 can communicate with another processing device, which in turn initiates a function associated with a detected touch or gesture. For example, the processor unit 740 can communicate with a central processing unit or digital signal processor of a gaming platform, a computer or the like, which interprets detected touches or gestures and controls aspects of a game or the like based on the detected inputs. Communications from the processor 740 can cause the other processor to execute instructions to cause events to occur on the screen, for example, steering a virtual car or moving a game character on the screen (possibly with corresponding audio outputs).

Various modifications may be made to the examples and embodiments described in the foregoing, and any related teachings may be applied in numerous applications, only some of which have been described herein. It is intended by the following claims to claim any and all applications, modifications and variations that fall within the true scope of the present teachings.

1. A touch sensor for determining position of a touch on a three dimensional object, the touch sensor comprising:
pluralities of first and second electrodes and an insulator between the first and second electrodes, the first and second electrodes and the insulator being mounted to a surface of the three-dimensional object,
the plurality of first electrodes being arranged in a first direction, and
the plurality of second electrodes being arranged in a second direction different from the first direction such that the first and second electrodes cross over each other to form touch sensing nodes at three-dimensional locations relative to the object; and
a processor configured to process a signal from one or more of the electrodes representing the touch at one or more of the sensing nodes, to determine a position of the touch on the three dimensional object.

2. The touch sensor of claim 1, wherein:
the insulator comprises an insulating substrate; and
at least one of the plurality of the first electrodes and the plurality of the second electrodes is formed on a surface of the insulating substrate.

3. The touch sensor of claim 1, wherein the processor is configured to process a plurality of detected touches and determine a gesture occurred, and when occurrence of a gesture is detected, to initiate performance of a function corresponding to the gesture.

4. The touch sensor of claim 3, wherein the function is selected from the group consisting of adjusting a volume level, turning power on to a device, and turning power off at a device.

5. The touch sensor of claim 1, wherein the three-dimensional object is cylindrical.

6. The touch sensor of claim 1, wherein the three-dimensional object is disc-shaped.

7. The touch sensor of claim 1, wherein:
the first electrodes form drive electrodes;
the second electrodes form sense electrodes; and
the touch sensor further comprises:
a drive unit connected to apply a drive signal to the first electrodes; and
a sense unit connected to sense a change in charge on the second electrodes and supply sensing results to the processor.

8. The touch sensor of claim 1, wherein the processor is configured to detect and track movement of touch positions to detect one or more gestures selected from the group consisting of: a push gesture, a pull gesture, a rotational gesture in a first direction, and a rotational gesture in a second direction opposite the first direction.

9. The touch sensor of claim 1, wherein the processor is configured to detect and track movement of touch positions to detect a three dimensional screwing movement at the object.

10. The touch sensor of claim 9, wherein the processor is further configured to detect distinguish between positive and negative movement in at least one direction of the three dimensional screwing movement.

11. The touch sensor of claim 1, wherein the processor is configured to detect and track movement of touch positions to detect a plurality of gestures including: a push gesture, a pull gesture, a rotational gesture in a first direction, a rotational gesture in a second direction opposite the first direction, and a three dimensional screw gesture.

12. A touch panel for placement on the surface of a three dimensional object, the touch panel comprising:
a plurality of first electrodes arranged in a first direction;
a plurality of second electrodes; and
an insulator between the first and second electrodes,
the plurality of second electrodes being arranged in a second direction different from the first direction such that the first and second electrodes cross over each other to form touch sensing nodes,
wherein the pluralities of first and second electrodes and the insulator are configured for mounting to the surface of the three-dimensional object in such a manner that each of the nodes will be located at a three-dimensional location relative to the object.

13. The touch panel of claim 12, wherein:
the insulator comprises an insulating substrate; and
at least one of the plurality of the first electrodes and the plurality of the second electrodes is formed on a surface of the insulating substrate.

14. The touch sensor of claim 12, wherein the three-dimensional object is cylindrical.

15. The touch sensor of claim 12, wherein the three-dimensional object is disc-shaped.
